(19) United States
(12) Patent Application Publication
(10) Pub. No.: US 2008/0181620 A1
(43) Pub. Date: Jul. 31, 2008

(54) CONTROL METHOD FOR OPTICAL PHASE MODULATION

(76) Inventor: Shinya Sasaki, Koganei (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/776,859

(22) Filed: Jul. 12, 2007

(30) Foreign Application Priority Data
Jan. 26, 2007 (JP) 2007-16333

(51) Int. Cl. H04B 10/04

(52) U.S. Cl. 398/198

(57) ABSTRACT

A QPSK modulator comprising: two phase modulators implemented in parallel for outputting the light phase-modulated with an information signal; a phase shifter for shifting the phase of the light phase-modulated with the first phase modulator of the two phase modulators and for outputting the phase-shifted light; and a combiner for combining output light of the phase shifter and output light of the second phase modulator, in which a drive signal generated by multiplexing a signal of a first and second frequencies and the information signal is inputted into the first and second phase modulators, and in which the QPSK modulator feeds back a detected amount to a voltage applied to the phase shifter so that the phase shift amount may be π/2, the detected amount of signals having the frequency of the difference between or the sum of the first and second frequency which are extracted from the modulated light.

### CLAIM OF PRIORITY

The present application claims priority from Japanese patent application JP 2007-016333 filed on Jan. 26, 2007, the content of which is hereby incorporated by reference into this application.

### BACKGROUND OF THE INVENTION

This invention relates to a method for optical communication, in particular to a method for modulating light used as carrier waves.

A binary modulation technology using light intensity is applied to a current optical communication system. More specifically, “0” and “1” as digital information are converted to on and off of light intensity on the side of a sender and the converted information is transmitted to an optical fiber. The light having propagated in the optical fiber is photoelectrically converted and the original information is demodulated on the side of a receiver.

In recent years, in proportion to the explosive popularization of the Internet, the channel capacity required for an optical communication system is extremely increasing. The channel capacity has heretofore been increased by increasing the speed of on and off of light, namely the modulating speed on the side of a sender. However, a method for increasing a channel capacity by increasing a modulating speed has the after-mentioned problems.

Firstly, a new electronic device and a new optical device allowing very high speed operations are necessary for turning on and off light at a high speed. The development of new devices takes high cost and long term. Further, as the modulating speed increases, a transmittable distance shortens by a restriction of the chromatic dispersion of an optical fiber. Generally speaking, when a bit rate doubles, the transmission distance is restricted to one fourth by the chromatic dispersion. Likewise, when a modulating speed increases, the transmittable distance shortens by a restriction of the polarization mode dispersion of an optical fiber. Generally speaking, when a bit rate doubles, the transmission distance is restricted to half by the polarization mode dispersion.

In view of the above situation, in recent years, as an optical modulation method for increasing a channel capacity, not the conventional method of binary modulation of light intensity but the modem method of using the phase of light is studied. In particular, Quaternary Phase Shift Keying (QPSK) is brought to attention since it has such characteristics as shown below. That is, in the case of QPSK, the symbol rate is half of the bit rate and hence a very high speed electronic device or an optical device that operates with the bit rate and is required in the conventional binary modulation of light intensity is unnecessary. Further, in QPSK, the transmission distance restricted by the chromatic dispersion of an optical fiber can be increased four times the communication range by the conventional method of the binary modulation of light intensity. Furthermore, the communication range restricted by polarization mode dispersion can also be increased twice the communication range by the method of the binary modulation of light intensity. For those reasons, QPSK is suitable for a long distance communication system.

A concrete modem method of QPSK is disclosed in JP 2004-516743 A. The configuration and operation principle of a QPSK transmitter are shown in FIG. 2 (a QPSK modulator 400 is shown in FIG. 2). Light outputted from a laser 100 is branched into two routes with a 1:2 optical coupler 101. The branched light is inputted into BPSK modulators 102X and 102Y.

A data stream for communication is divided into two data streams (the two data streams are called I and Q, respectively) with a serial/parallel (S/P) converter 300. It is noted that when one time slot of an original information data stream is defined as T, one time slot of the two data streams (I and Q) is 2T. The inverse of the time slot 2T is the symbol rate of QPSK.

A data stream is converted into voltage pulses that are suitable for modulation with drivers 106C and 106D. For example, a voltage pulse and a bias voltage are adjusted so that “0” of a digital signal may correspond to the optical phase 0 and “1” thereof may correspond to the optical phase π. Then the voltage pulse signals sent from the drivers 106C and 106D are inputted into BPSK modulators 102X and 102Y, respectively. Light outputted from the laser 100 is modulated with the BPSK modulators 102X and 102Y. The light modulated with the modulator 102X changes the phase by φ that is determined by a DC bias 3 in a phase shifter 103. In an ideal QPSK transmitter, φ is π/2.

Light 201A outputted from the phase shifter 103 and light 201B outputted from the BPSK modulator 102Y are synthesized by a 2:1 optical coupler 104. The synthesized light is used for transmitting light 200. The transmitting light 200 is sent to an optical fiber as a transmission line. The signal space of the transmitting light 200 is shown in FIG. 3A. FIG. 3A shows ideal signal points in the case of φ=π/2. In FIG. 3A, the signal points shown with small circles “O” represent electric fields in the cases where the data streams I and Q take “0” and “1” respectively. In a QPSK transmitter, it is important that the phase +is precisely set at π/2.

If the phase φ deviates from π/2, the light 200 formed by synthesizing the light 201A and 201B outputted from the two BPSK modulators is synthesized in the state of being deviated as shown in FIG. 3B and becomes intensity-modulated light. That is, the square of the distance between a signal point and the original point is proportional to the intensity of light but, in the case of FIG. 3B, the distances of the signal points (0, 0) and (1, 1) from the original point are different from the distances of the other two signal points (1, 0) and (0, 1) from the original point.

R. A. Griffin, “Integrated DQPSK Transmitters,” OFC2005, OWE3 discloses that two-photon absorption caused in a Gallium Arsenide (GaAs) substrate comprising a compound semiconductor is used in order to set the phase φ at π/2. The electric current of a signal generated by the two-photon absorption is proportional to the square of light intensity. Therefore, by controlling the phase φ so that the signal may be smallest, the phase difference between the light 201A and 201B outputted from two Mach-Zehnder (MZ) modulators is set at π/2 as a result.

Consequently, in a modulator using a compound semiconductor such as GaAs or Indium Phosphide (InP) for example, a control method using two-photon absorption is effective. In contrast, in a modulator not using a compound semiconductor, e.g. in a modulator wherein lithium niobate (LiNbO₃) or the like as a ferroelectric material is used, the two-photon absorption scarcely occurs and the control method is hardly adopted.

In many cases, a Mach-Zehnder modulator is used as a BPSK modulator of a QPSK transmitter shown in FIG. 2.

FIG. 5 shows the modulation characteristic of an MZ modulator. The vertical axis in FIG. 5 represents a value obtained by normalizing an optical output power (Pout) of an MZ modulator with an optical input power (Pin), and the horizontal axis represents the difference (V1−V2) of voltages applied to two optical waveguides in the MZ modulator with a driver. The modulation characteristic of an MZ modulator is represented by an expression (1).

Pout/Pin=[1+cos{π·(V1−V2)/V_{π}}]/2 (1)

Vπ is a voltage necessary for changing the phase of light by π. The phase of light is set at: 0 when a voltage is Vπ or lower; and π when a voltage is Vπ or more. When an MZ modulator is used as a phase modulator, this phase change is used. On the contrary, when an MZ modulator is used as an intensity modulator, the characteristic represented by the expression (1) is used.

Operations of an MZ modulator as an intensity modulator are explained in detail with FIG. 4. Digital data tried to be sent (e.g., 1, 0, 1, 1, 1, 0, 1, 0, 1, 0, 1, 1, 1) are converted into voltage pulses having a voltage amplitude of Vπ and a DC bias of Vπ with a driver (106C or 106D in FIG. 2). The MZ modulator is driven by the digital data converted into the voltage pulses. According to the modulation characteristic (represented by the expression (1))shown in FIG. 4, the output light of the MZ modulator is converted into signals wherein the intensity of light is turned on and off as optical signals shown in FIG. 4.

Next, operations of a phase modulator are explained in detail with FIG. 5. Digital data tried to be sent (e.g., 1, 0, 1, 1, 1, 0, 1, 0, 1, 0, 1, 1, 1) are converted into voltage pulses having a voltage amplitude of 2×Vπ and a DC bias of Vπ with a driver (106C and 106D in FIG. 2) and thereby the MZ modulator is driven. As the modulation characteristic shown in FIG. 5, the phase of light is: 0 when a drive voltage is smaller than Vπ; and π when a drive voltage is larger than Vπ. As a result, the intensity of the light outputted from the MZ modulator is constant (more precisely the intensity varies between the rise time and the fall time of a drive voltage pulse) and the phases of light change to 0 and π (in the example, π, 0, π, π, π, 0, π, 0 , π, 0, π, π, π).

Meanwhile, it is known that the voltage-optical output characteristic of an MZ modulator using LN used in many optical communication systems changes with the passage of time due to the ambient temperature, electrification caused by a bias voltage, and the like. The phenomenon is concretely shown in FIG. 7. That is, the modulation characteristic of an MZ modulator in the initial state is shown with the dotted line in FIG. 7. However, the modulation characteristic of the MZ modulator changes to the modulation characteristic shown with the solid line with the passage of time. The change appears as if the modulation characteristic drifts laterally on the drive voltage axis as shown in FIG. 7. By such a drift phenomenon, the shape and the phase of an optical pulse obtained from the MZ modulator driven by applying a constant bias voltage change with the passage of time. As a result, by the drift phenomenon, the communication characteristic (a bit error rate and the like) of the optical communication system deteriorates.

The drift phenomenon occurs not only in the modulation characteristic of an MZ modulator but also in the phase shifter of an optical QPSK modulator. This is explained with FIG. 2. The phase φ of a phase shifter 103 is set so as to be φ/2 as an ideal value by a DC bias 3. When the phase shifter 103 is operated while the DC bias 3 at the time of the setting is maintained however, the phase φ drifts from π/2 with the passage of time by the drift phenomenon. When the phase φ drifts from π/2, unnecessarily intensity-modulated light is produced and the communication characteristic deteriorates as shown in FIG. 3B.

In order to suppress the influence of the drift phenomenon on the modulation characteristic of an MZ modulator made of LN, a solution applicable in the case of operating as an intensity modulator is proposed. For example, according to JP 2642499 B, amplitude modulation is applied to a drive voltage of an optical modulator at a low frequency (f₀) as shown in FIG. 6. Then a part of the light outputted from the optical modulator is branched with an optical coupler. The light extracted by the branching is subjected to photoelectric conversion. It is noted that the drive voltage signals shown in FIG. 6: include voltage signals corresponding to an information data stream; and are expressed merely as a repeated pattern of 0 and 1. In reality however, the drive voltage signals are a random data stream as shown in FIG. 4. Therefore, it should be noted that the simple and easy expression is used also in figures other than FIG. 6.

When the influence of the drift phenomenon is not seen and an optimum bias voltage is applied to an optical modulator, as shown in FIG. 6, the aforementioned low frequency (f0) component is not included in the signals produced by photoelectrically converting the light outputted from an MZ modulator and only the signals of the frequency component of 2×f0 are included. On the other hand, when the bias voltage drifts from the optimum point due to the drift phenomenon of the modulation characteristic as shown in FIG. 7, the aforementioned low frequency (f0) component is included in the light outputted from an MZ modulator. As a result, the generated signals are photoelectrically converted and the photoelectrically converted light is fed back to the bias voltage of the modulator. Then, the bias voltage is controlled so that the low frequency (f0) component may take the smallest value. That is, the bias voltage is the optimum bias point of the modulation characteristic wherein the drift phenomenon appears. As a result, the influence of the drift phenomenon can be suppressed by optimally controlling the bias voltage.

This method can be applied to an MZ modulator used as an intensity modulator but cannot be applied when an optical QPSK phase shifter is controlled.

### SUMMARY OF THE INVENTION

A conventional technology that uses two-photon absorption of a modulator substrate as stated above is proposed in order to suppress the temporal change of the characteristic of the phase shifter (103 in FIG. 2) of a QPSK modulator. However, in the case of an optical modulator made of a material other than a compound semiconductor, e.g. LN as a ferroelectric material, two-photon absorption probability is very low and the conventional technology cannot be applied to the optical modulator. Further, a means for suppress the influence of the drift phenomenon on an optical modulator made of LN is also proposed. However, the means is effective for an intensity modulator but cannot be applied to an optical QPSK modulator.

This invention solves the problem in that the characteristic of an optical QPSK modulator changes with the passage of time. More specifically, this invention solves the problem in that: the phase characteristic of the phase shifter of an optical QPSK modulator and the modulation characteristic of an MZ modulator change by the drift phenomenon that changes with the passage of time; and the communication characteristic varies unstably. Consequently, this invention is applicable to an optical QPSK modulator having a phase shifter and an MZ modulator made of not only a compound semiconductor but also another material.

A representative aspect of this invention is as follows. That is, there is provided a QPSK modulator which outputs modulated light, comprising: two of phase modulators implemented in parallel, each for outputting the light phase-modulated with input an information signal; a phase shifter for shifting the phase of the light phase-modulated by the first phase modulator of the two phase modulators and for outputting the phase-shifted light; and a multiplexer for multiplexing output light from the phase shifter and output light from the second phase modulator. In the QPSK modulator, a drive signal generated by multiplexing a signal of a first frequency and the information signal is inputted into the first phase modulator, and a drive signal generated by multiplexing a signal of a second frequency and the information signal is inputted into the second phase modulator. The QPSK modulator feeds back a detected amount to a voltage which is applied to the phase shifter so that the phase shift amount may be π/2, the detected amount of signals having the frequency of the difference between or the sum of the first frequency and the second frequency which are extracted from the modulated light.

Another representative aspect of this invention is as follows. That is, there is provided a QPSK modulator which outputs modulated light, comprising: two of phase modulators implemented in parallel, each for outputting the light phase-modulated with input an information signal; a phase shifter for shifting the phase of the light phase-modulated with the first phase modulator of the two phase modulators and for outputting the phase-shifted light; and a multiplexer for multiplexing output light from the phase shifter and output light from the second phase modulator. In the QPSK modulator, a drive signal generated by multiplexing a signal of a first frequency and the information signal is inputted into the first phase modulator, and a drive signal generated by multiplexing a signal of a second frequency and the information signal is inputted into the second phase modulator. The QPSK modulator controls the bias voltages which is applied to the phase modulators so that the detected amounts of the signals of the first frequency and the second frequency which are extracted from the modulated light may be the minimum respectively.

According to an aspect of this invention, it is possible to: stabilize a phase shift amount (to π/2 for example) by applying feedback to a drive voltage that determines the phase shift amount of a phase shifter; and thus stabilize the operations of an optical QPSK modulator. Further, it is possible to: stabilize a modulation characteristic by applying feedback to drive signals (a DC bias for example) of a phase modulator even when the modulation characteristic of the phase modulator drifts; and thus stabilize the operations of an optical QPSK modulator. As a result, a stable communication system can be established.

### BRIEF DESCRIPTION OF THE DRAWINGS

The present invention can be appreciated by the description which follows in conjunction with the following figures, wherein:

FIG. 1 is a block diagram showing the configuration of an optical QPSK modulator of the first embodiment in accordance with this invention;

FIG. 2 is a view explaining the configuration and the operations of an optical QPSK transmitter;

FIG. 3A is a view showing the allocation of ideal signal points of QPSK signals in a phase space;

FIG. 3B is a view showing the allocation of nonideal signal points of QPSK signals in a phase space;

FIG. 4 is a view explaining the relationship between a drive voltage and an optical output when an MZ modulator is used as an intensity modulator;

FIG. 5 is a view explaining the relationship between a drive voltage and an optical output when an MZ modulator is used as a phase modulator;

FIG. 6 is a view explaining the relationship between amplitude-modulated drive voltage signals and an optical output when an MZ modulator is used as an intensity modulator;

FIG. 7 is a view explaining the relationship between amplitude-modulated drive voltage signals and an optical output when an MZ modulator is used as an intensity modulator and a modulation characteristic drifts;

FIG. 8 is a view explaining the relationship between drive voltage signals amplitude-modulated in anti-phase and a modulation characteristic of the first embodiment in accordance with this invention;

FIG. 9 is a view explaining the relationship between drive voltage signals amplitude-modulated in in-phase, a modulation characteristic, and an optical output when an MZ modulator is used as a phase modulator of a second embodiment in accordance with this invention;

FIG. 10 is a block diagram showing the configuration of an optical QPSK modulator of a third embodiment in accordance with this invention;

FIG. 11 is a view explaining the relationship between drive voltage signals amplitude-modulated in an in-phase and an optical output when the modulation characteristic of an MZ modulator used as a phase modulator drifts of the third embodiment in accordance with this invention;

FIG. 12 is a block diagram showing the configuration of an optical QPSK modulator of a fourth embodiment in accordance with this invention;

FIG. 13 is a block diagram showing the configuration of an optical QPSK modulator of a fifth embodiment in accordance with this invention;

FIG. 14 is a block diagram showing a concrete example of the configuration of a driver of the MZ modulator according to the first embodiment in accordance with this invention; and

FIG. 15 is a block diagram showing another concrete example of the configuration of a driver of the MZ modulator according to the second embodiment.

### DETAILED DESCRIPTION OF THE PREFERRED EMBODIMENTS

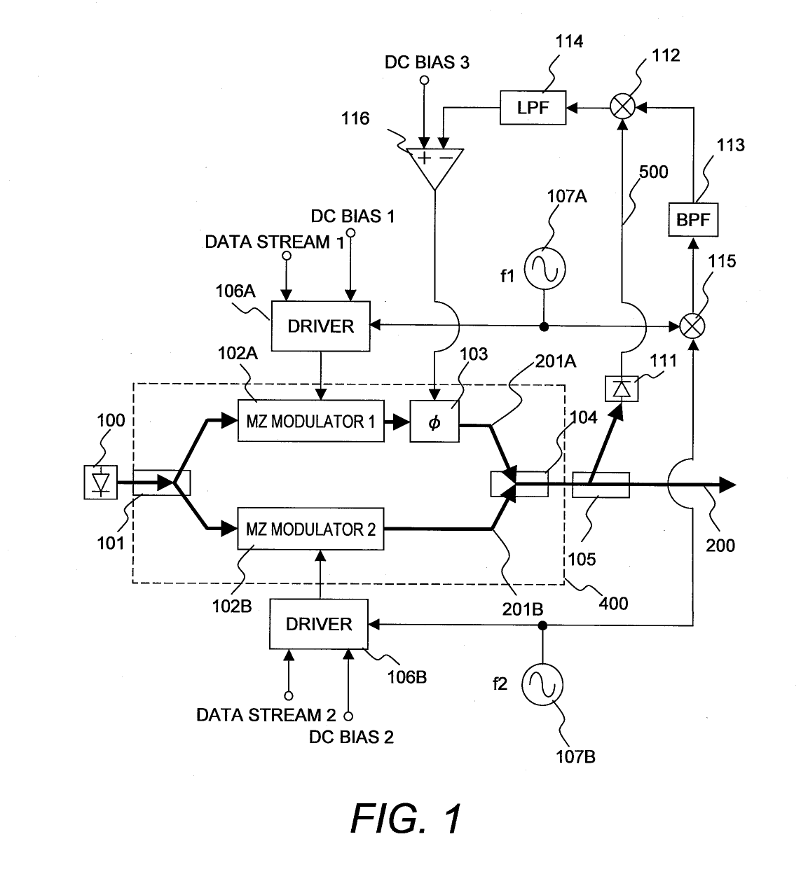

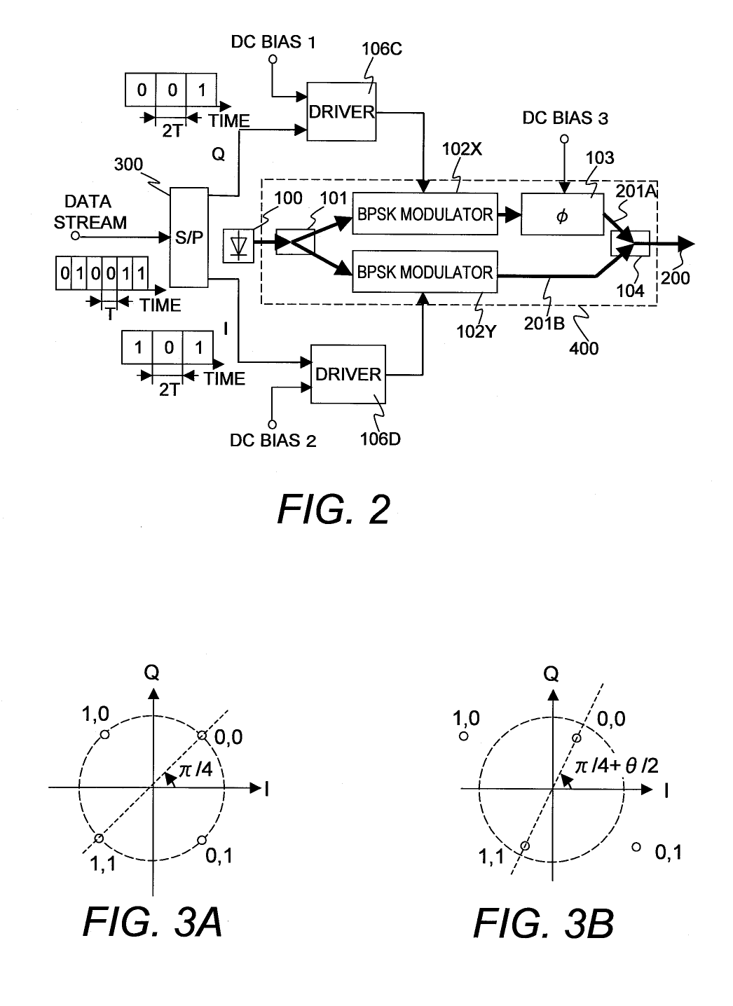

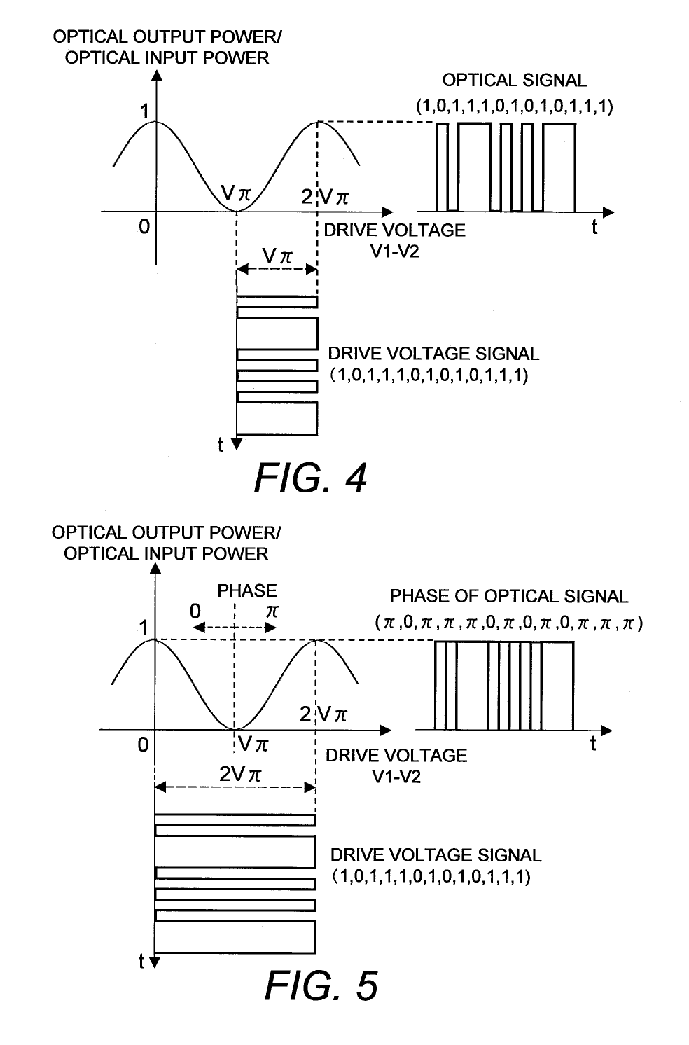

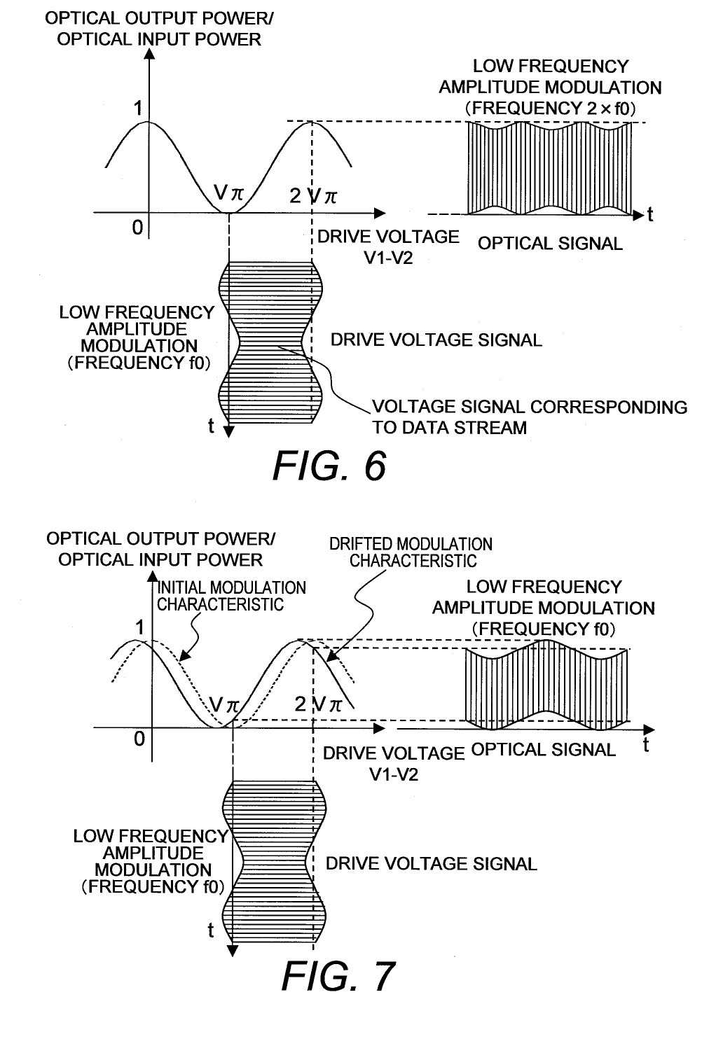

Embodiments according to this invention are explained with FIGS. 1, 10, 12, 13, and others.

### Embodiment 1

Firstly, an optical QPSK modulator of a first embodiment according to this invention is explained with FIG. 1.

Continuous light outputted from a laser 100 is branched into two streams with a 1:2 optical coupler (with one input and two outputs) 101. The branched light is inputted into MZ modulators 102A and 102B respectively. The MZ modulator 102A modulates the phase of the light to “0” and “π” in accordance with the digital signals “0” and “1” of an information data stream 1.

A driver 106A converts the information data stream 1 into a drive voltage pulse stream so that the MZ modulator 102A may operate as a phase modulator. The driver 106A adds a DC bias 1 to the drive voltage pulse stream. FIG. 5 shows concrete setting of a voltage amplitude and a DC bias. Further, the driver 106A applies amplitude modulation to the drive pulse stream with the signals of frequency f1 outputted from an oscillator 107A. The frequency f1 is set a frequency sufficiently lower than the bit rate of the information data stream 1 (e.g., when the bit rate of the information data stream 1 is 10 Gbit/s, f1 is set at 1 KHz or lower). Resultantly, the signals shown in FIG. 8 are applied to the MZ modulator 102A.

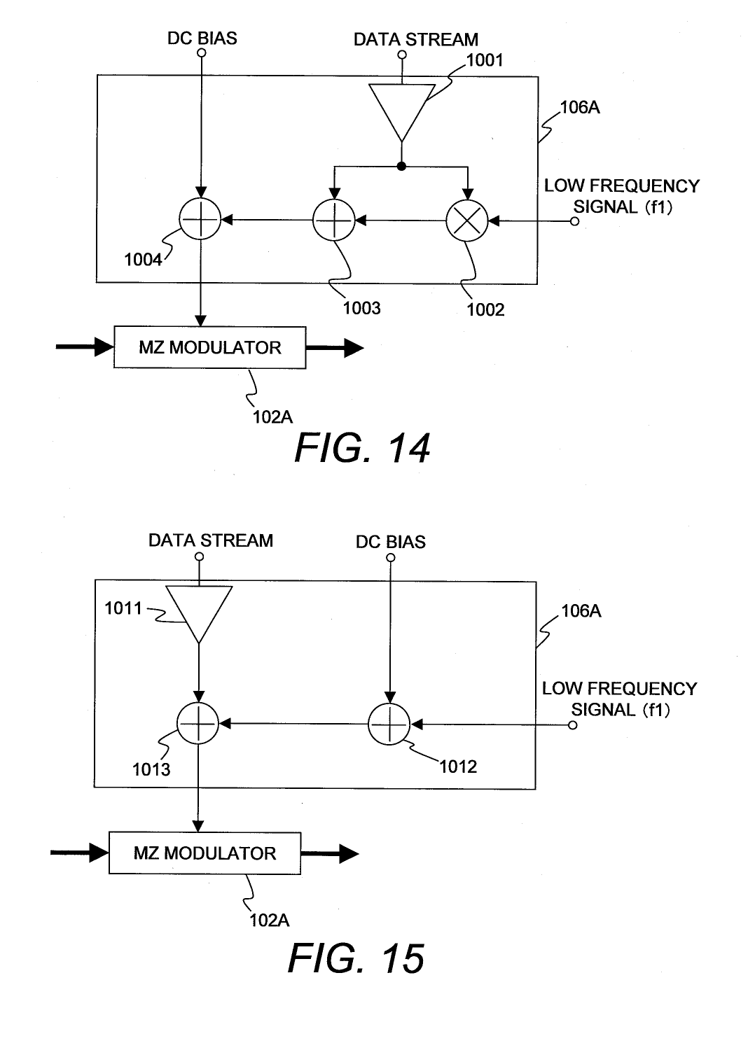

A concrete example of the configuration of one of the drivers 106A and 106B is shown in FIG. 14.

An information data stream is amplified to an amplitude (concretely 2×Vπ) required for the drive of an MZ modulator with an amplifier 1001, and the amplified signals are subjected to amplitude modulation with low frequency signals (f1) outputted from an oscillator 107A by using a mixer (a multiplier) 1002 and an adder 1003. Then a DC bias is added to the modulated signals with an adder 1004 so that a desired bias may be applied to the MZ modulator 102A.

FIG. 14 shows an example of a driver in the case where an MZ modulator has one input electrode. In the case where an MZ modulator has a so-called dual pulse drive electrode or a DC bias is applied from another terminal, the circuit configuration of the driver is different from that of the driver shown in FIG. 14. However, such a circuit configuration of a modified example can easily be obtained by applying a known technology to the driver shown in FIG. 14.

The MZ modulator 102B also modulates the phase of light to “0” and “π” in accordance with the digital signals “0” and “1” of an information data stream 2. The driver 106B converts the information data stream 2 into a drive voltage pulse stream. The driver 106B adds a DC bias 2 to the converted drive voltage pulse stream so that the MZ modulator 102B may operate as a phase modulator. Further, the driver 106B applies amplitude modulation to the drive pulse stream with the signals of the frequency f2 outputted from an oscillator 107B. The frequency f2 is set a frequency sufficiently lower than the bit rate of the information data stream 2.

The two different oscillators 107A and 107B are used in this case but, if one oscillator can generate signals of different frequencies (f1 and f2), only the oscillator may be used.

Further, the frequencies of signals generated by the oscillators 107A and 107B may be identical.

The phase of the light outputted from one of the two phase modulators 102A and 102B (concretely, the MZ modulator 1 (102A) in FIG. 1) is shifted by φ with a phase shifter 103. The phase shift +is preferably π/2. The phase shift φ of the phase shifter 103 is determined by a voltage applied to the phase shifter.

The light 201A outputted from the phase shifter 103 and the light 201B outputted from the MZ modulator 102B are multiplexed with a 2:1 optical coupler (with two inputs and one output) 104. The multiplexed light is light subjected to QPSK modulation, and optical signals used for transmitting data in optical communication. The light propagates in an optical fiber as a communication channel and is sent to a light receiver.

A major part of the light outputted from the QPSK modulator 400 is led to a communication channel as light 200 used for communication as stated earlier, but a part of the light is separated with a 1:2 optical coupler (with one input and two outputs) 105 and led to a photoelectric converter 111. The separated optical signals are converted into electric signals 500 with the photoelectric converter 111 and then inputted into a mixer 112.

Meanwhile, from parts of the signals outputted from the oscillators 107A and 107B, signals having the difference frequency (|f1−f2|) component are generated with a mixer 115. The center frequency of a band pass filter (BPF) 113 is set at the difference frequency (|f1−f2|) and the output of the band pass filter 113 is led to the mixer 112.

Since the converted electric signals 500 led to the mixer 112 contain the difference frequency component given by an expression (2) when the degree of amplitude modulation is low, the signals proportional to the difference frequency component, among the signals 500, are contained in the output of the mixer 112. The signals proportional to the difference frequency component are extracted by making the output signals of the mixer 112 pass through a low pass filter (LPF) 114.

−cos(φ)·cos(Δ₁)·cos(Δ₂)·J₁(0.5·π·m₁)·cos{2·π·(f1−f2)·t} (2)

In the expression (2), φ represents the amount of the phase shift generated with the phase shifter 103, Δ₁ represents the drift amount of the modulation characteristic of the MZ modulator 1, Δ₂ represents the drift amount of the modulation characteristic of the MZ modulator 2, ml represents the degree of amplitude modulation of the drive voltage signals applied to the MZ modulator 1, and m₂ represents the degree of amplitude modulation of the drive voltage signals applied to the MZ modulator 2. Further, J₁ represents First order Bessel function of the First Kind.

As it is obvious from the expression (2), the signals proportional to the difference frequency component are, as the nature: zero when the phase φ of the phase shifter 103 is π/2; positive values when φ is π/2 or less; and negative values when π is π/2 or more. Consequently, when the signals are superimposed on a DC bias 3 (the DC bias 3 is a voltage by which the phase shift φ takes π/2 as the ideal value with the phase shifter 103 as stated above) of the phase shifter 103 through a differential amplifier 116, φ is stabilized as the desired value π/2.

In the first embodiment, the explanations have been made on the basis of the case where the center frequency of the band pass filter 113 is set at the difference frequency (|f1−f2|) and the component of the sum frequency (f1+f2) is also included in the electric signals 500. Consequently, it is also acceptable to set the center frequency of the band pass filter 113 at the sum frequency (f1+f2) and carry out feedback control with the sum frequency (f1+f2) component.

Further, although a 1:2 optical coupler 105 is used in the first embodiment, it is possible to: replace the 2:1 optical coupler 104 with a 2:2 optical coupler (with two inputs and two outputs) in the QPSK modulator 400; and connect one of the output ports to the photoelectric converter 111 and use the other port for the light 200 used for communication.

Furthermore, this embodiment can be applied also to the case where the QPSK modulator 400 is integrated on a substrate made of one material (e.g., a ferroelectric material such as LN or a compound semiconductor such as GaAs or InP).

In addition, other embodiments described below can also be applied to an integrated QPSK modulator.

### Embodiment 2

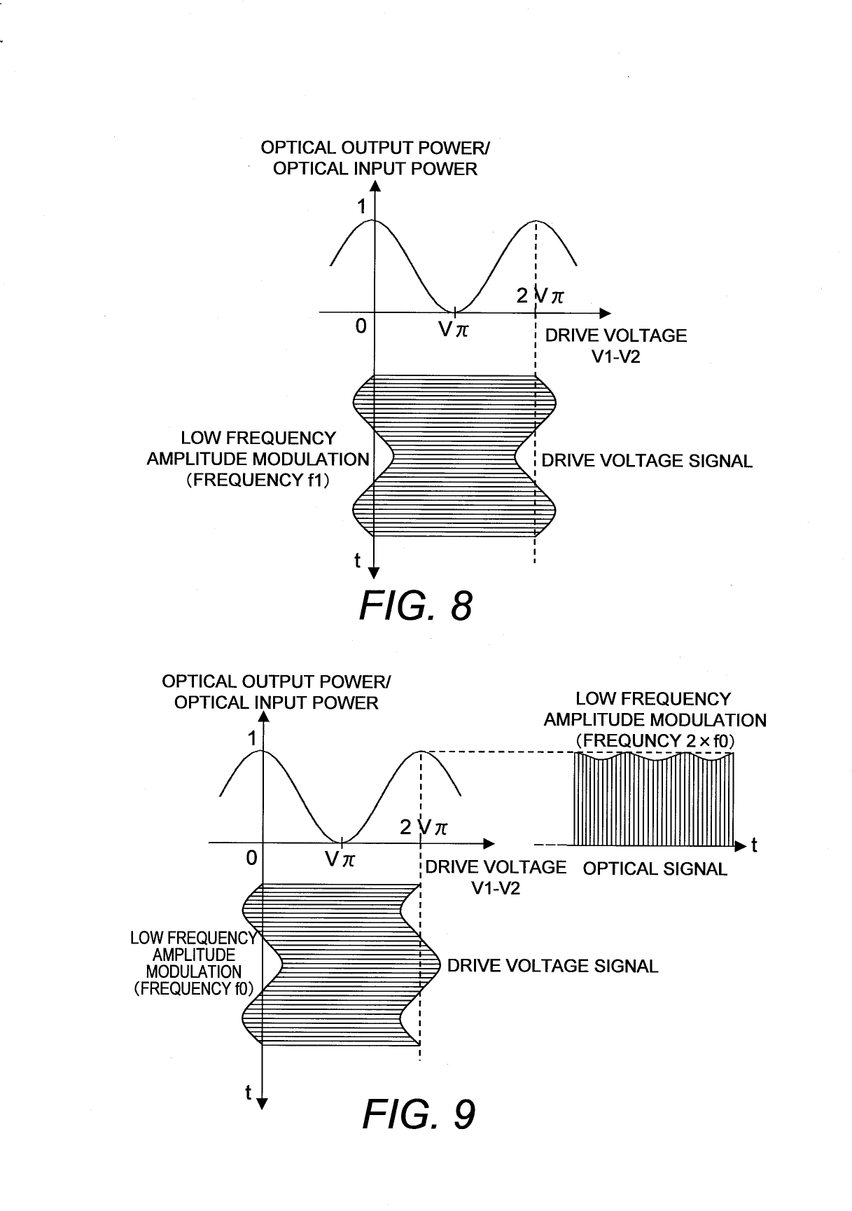

A second embodiment will be described hereinafter. The second embodiment has the same circuit configuration of the optical QPSK modulator as that of the first embodiment but the method for applying amplitude modulation to drive voltage signals of the MZ modulators is different. More specifically, the relationship between drive voltage signals and a modulation characteristic of an MZ modulator in the second embodiment is shown in FIG. 9.

In the second embodiment, the phase of the amplitude modulation at the drive voltage signal level where the phase of light is “0” (V1−V2=0 in FIG. 9) is identical to the phase of the amplitude modulation at the drive voltage signal level where the phase of light is “π” (V1−V2=2Vπ in FIG. 9). Note that, in the aforementioned first embodiment, the phases at the drive voltage signal levels in the cases of “0” and “π” are opposite as shown in FIG. 8.

In the case of the second embodiment, the intensity of the difference frequency component |f1−f2| (or the sum frequency component f1+f2) required for controlling the bias voltage applied to an MZ modulator is smaller than the intensity of the difference frequency component in the case of the first embodiment but the intensity in the case of the second embodiment is sufficient for controlling a bias voltage by making use of the difference frequency component. Consequently, in the second embodiment, the phase shift φ of the phase shifter 103 is stably set at π/2 by the use of the difference frequency component.

A concrete example of one of the drivers 106A and 106B according to the second embodiment is shown in FIG. 15. The low frequency signals outputted from the oscillator 107A or 107B are added to a DC bias in an adder 1012. Signals of an information data stream the amplitude of which is amplified to 2×Vπ are added to the output of the adder 1012 in an adder 1013. An MZ modulator is driven by the signals outputted from the adder 1013.

### Embodiment 3

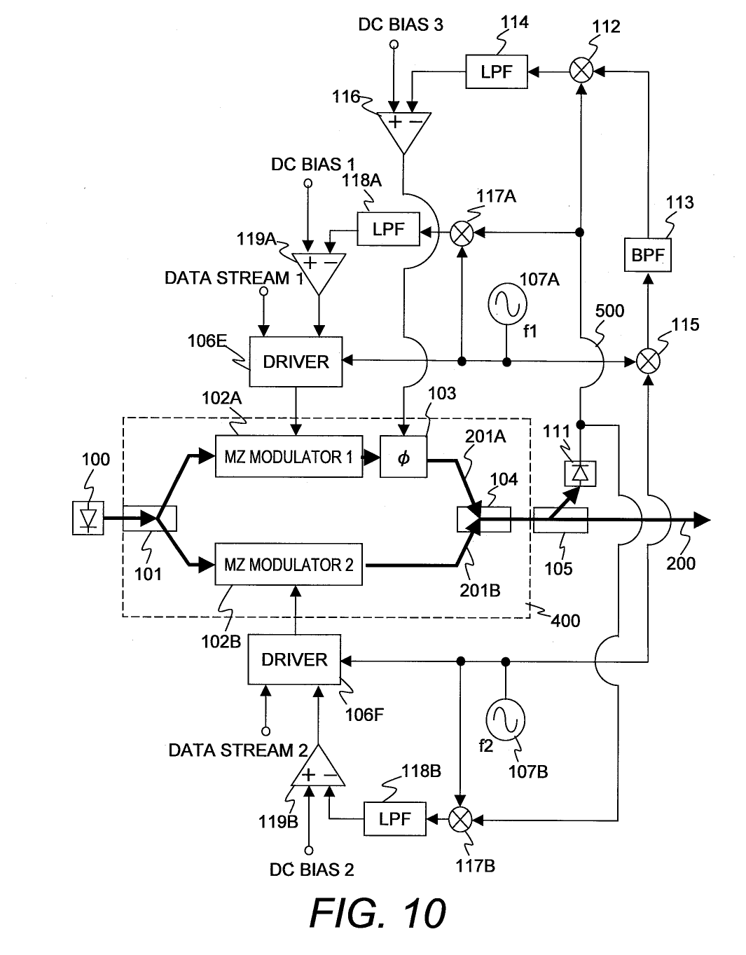

A third embodiment will be described hereinafter. The third embodiment is hereunder explained with FIG. 10. In the third embodiment, unlike the aforementioned first embodiment, the drift phenomenon of the modulation characteristics of the two MZ modulators is compensated by using low frequency signals (frequencies f1 and f2) outputted from the two oscillators 107A and 107B.

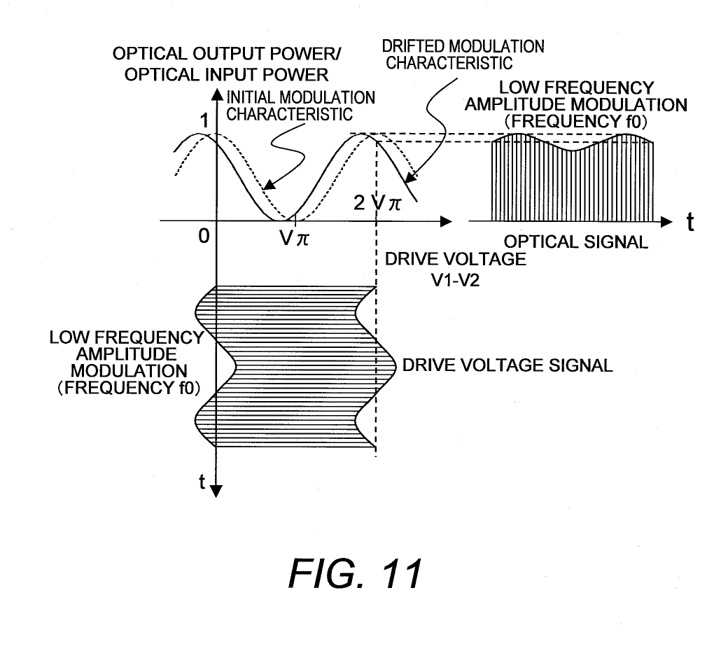

More specifically, in the drive voltage signals applied to the two MZ modulators 102A and 102B, similarly to the aforementioned second embodiment, the phases of the amplitude modulation of the low frequency signals (frequency f0) applied to the drive signal level of phase “0” and the drive signal level of phase “π” shown in FIG. 9 are identical. In the case of the third embodiment, as shown in FIG. 11, when the modulation characteristics of the MZ modulators 102A and 102B drift, amplitude modulation of the frequency f0 is applied to the light outputted from the MZ modulators 102A and 102B. When the bias voltages of the MZ modulators 102A and 102B are set correctly, the intensities of the output light of the MZ modulators 102A and 102B do not vary at the frequency f0 (oscillate at the frequency 2×f0) as shown in FIG. 9.

Consequently, by controlling the bias voltages applied to the MZ modulators 102A and 102B so that the component of the frequency f0 of the light outputted from the MZ modulators 102A and 102B may be the minimum, a QPSK modulator wherein the drifts of the modulation characteristics of the MZ modulators 102A and 102B are compensated can be realized.

It is noted that the frequencies of the signals outputted from the two oscillators 107A and 107B may be identical to each other.

In the third embodiment, as shown in FIG. 10, signals of the frequencies f1 and f2 are applied to two MZ modulators 102A and 102B respectively and an optical coupler 105 extracts a part of the light outputted from a QPSK modulator 400. The part of the extracted output light is converted into electric signals 500 with a photoelectric converter 111. The component the frequency of which is |f1−f2| (or f1+f2) is extracted from the electric signals 500. Then by using the extracted signals, a phase shifter 103 is controlled so that the phase shift φ of the phase shifter 103 may be π/2. This is the same as the aforementioned second embodiment.

In the third embodiment, the component the frequency of which is f1 in the electric signals 500 is extracted with a mixer 117A and a low pass filter (LPF) 118A and the component of the frequency f2 is extracted with a mixer 117B and a low pass filter (LPF) 118B. Then the extracted signals are added to a DC bias 1 and a DC bias 2 with differential amplifiers 119A and 119B respectively. The component the frequency of which is f1 (or f2) in the electric signals 500 is represented by an expression (3) when the degree m of the amplitude modulation caused by low frequency signals is low.

sin(2·Δ)·J₁(2·π·m)·cos(2·π·f1·t) (3)

In the expression (3), J₁ represents First order Bessel function of the First Kind and A represents the drift amount of the modulation characteristic of an MZ modulator. As it is obvious from the expression (3), the component of the frequency f1 is: 0 when Δ is 0; positive when Δ is positive; and negative when Δ is negative. Consequently, by feeding back the component that oscillates at the frequency f1 in the electric signals 500 to the DC bias, the MZ modulator is controlled so that the drift amount Δ of a modulation characteristic may be zero. By so doing, the drifts of the modulation characteristics of the MZ modulators 102A and 102B are compensated.

### Embodiment 4

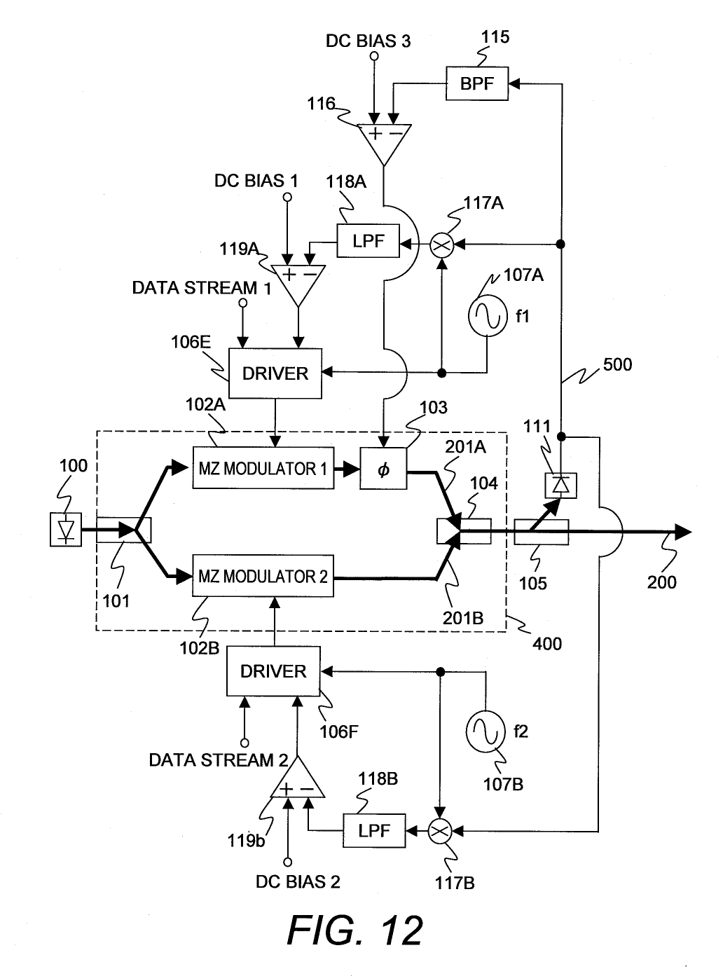

The fourth embodiment is explained with FIG. 12. In the fourth embodiment, in order to stabilize two MZ modulators 102A and 102B, the MZ modulators 102A and 102B use the signals (frequencies f1 and f2 respectively) generated with the oscillators 107A and 107B respectively. This point is the same as the aforementioned third embodiment.

However, in the fourth embodiment, in order to stabilize the phase shift φ of a phase shifter 103 at π/2, not the signals of the frequency |f1−f2| (or f1+f2) included in the electric signals 500 like in the aforementioned third embodiment but the high frequency component of the electric signals 500 is used. When the phase shift of the phase shifter 103 deviates from the ideal phase shift π/2, the distance of each signal point from the original point varies as shown in FIG. 3B.

The signal points vary in accordance with a symbol rate and hence the signal points vary at a very high speed (at a difference by several orders of magnitude in comparison with the frequencies f1 and f2) such as 10 Gbit/s, for example. Consequently, the signals the frequency of which is sufficiently higher than f1, f2, and f1+f2 at the extent of the symbol rate in the electric signals 500 are extracted with a band pass filter (BPF) 115 shown in FIG. 12. The extracted high frequency component is fed back to a DC bias 3 of the phase shifter 103 through a differential amplifier 116 and thereby the phase shift Δ of the phase shifter 103 is stabilized at π/2.

### Embodiment 5

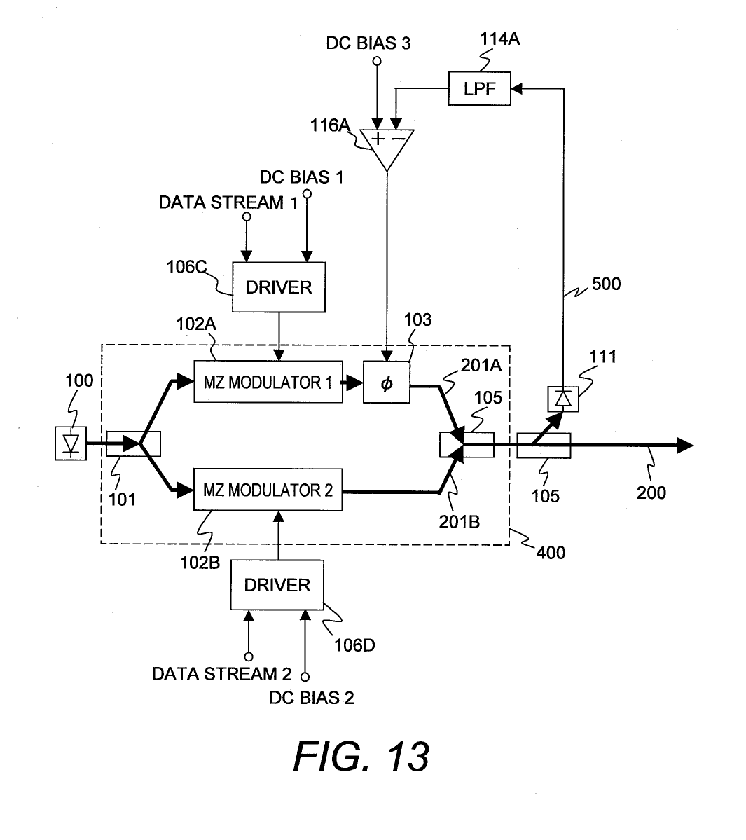

The fifth embodiment is explained with FIG. 13. In the fifth embodiment, it is assumed that the modulation characteristics of two MZ modulators 102A and 102B are stable. In this case, the oscillators for low frequency signals used in the aforementioned fourth embodiment are not necessary. In the fifth embodiment, in order to stabilize a phase shifter 103, in the same way as the fourth embodiment, a part of the output light of a QPSK modulator is extracted and the frequency component varying at the extent of a symbol rate in the electric signals 500 produced by photoelectrically converting the extracted light is extracted with a low pass filter (LPF) 114A. Then, by feeding back the extracted signals to a DC bias 3 of the phase shifter 103 through a differential amplifier 116A, the phase shift φ of the phase shifter 103 is stabilized at π/2.

It is noted that, as the low pass filter 114A, a filter the cutoff frequency of which is about half of the symbol rate can be used as an example.

While the present invention has been described in detail and pictorially in the accompanying drawings, the present invention is not limited to such detail but covers various obvious modifications and equivalent arrangements, which fall within the purview of the appended claims.

What is claimed is:

1. A QPSK modulator which outputs modulated light, comprising:
two of phase modulators implemented in parallel, each for outputting the light phase-modulated with input an information signal;
a phase shifter for shifting the phase of the light phase-modulated by the first phase modulator of the two phase modulators and for outputting the phase-shifted light; and
a combiner for combining output light from the phase shifter and output light from the second phase modulator,
wherein a drive signal generated by multiplexing a signal of a first frequency and the information signal is inputted into the first phase modulator,
wherein a drive signal generated by multiplexing a signal of a second frequency and the information signal is inputted into the second phase modulator, and
wherein the QPSK modulator feeds back a detected amount to a voltage which is applied to the phase shifter so that the phase shift amount may be π/2, the detected amount of signals having the frequency of the difference between or the sum of the first frequency and the second frequency which are extracted from the modulated light.

2. The QPSK modulator according to claim 1,
wherein the QPSK modulator further comprises:
at least one oscillator for outputting a signal having the first frequency and a signal having the second frequency which is different from the first frequency;
a distribution unit for extracting a part of the light outputted from the combiner;
a photoelectric converter for photo-electrical converting the light extracted by the distribution unit to an electric signal; and
a filter for extracting the component of the frequency of the difference between or the sum of the first frequency and the second frequency from the electric signal converted with the photoelectric converter,
wherein a first drive signal of the drive signals generated by applying amplitude modulation with the information signal to the signals of the first frequency is inputted into the first phase modulator;
wherein a second drive signal of the drive signals generated by applying amplitude modulation with the information signal to the signals of the second frequency is inputted into the second phase modulator; and
wherein the QPSK modulator feeds back a detected amount to a voltage which is applied to the phase shifter so that the phase shift amount may be π/2, the detected amount of signals having the frequency of the difference between or the sum of the first frequency and the second frequency which are extracted by the filter.

3. The QPSK modulator according to claim 2, wherein the phase modulators are MZ modulators which are driven so that the amplitude modulation at a drive signal level corresponding to the case where the phase of the optical output of the MZ modulators is “0” and the amplitude modulation at a drive signal level corresponding to the case where the phase of the optical output thereof is “π” may take anti-phase.

4. The QPSK modulator according to claim 2, wherein the phase modulators are MZ modulators which are driven so that the amplitude modulation at a drive signal level corresponding to the case where the phase of the optical output of the MZ modulators is “0” and the amplitude modulation at a drive signal level corresponding to the case where the phase of the optical output thereof is “π” may take an in-phase.

5. The QPSK modulator according to claim 4, further comprising
filters extracting the components of the first frequency and the second frequency respectively from among the electric signals converted with the photoelectric converter,
wherein the phase modulators control the bias voltages applied to the phase modulators so that the detected amounts of the signals of the first frequency and the second frequency extracted with the filters may be the minimum respectively.

6. The QPSK modulator according to claim 1, wherein the first frequency is equal to the second frequency.

7. A QPSK modulator which outputs modulated light, comprising:
two of phase modulators implemented in parallel, each for outputting the light phase-modulated with input an information signal;
a phase shifter for shifting the phase of the light phase-modulated with the first phase modulator of the two phase modulators and for outputting the phase-shifted light; and
a combiner for combining output light from the phase shifter and output light from the second phase modulator,
wherein a drive signal generated by multiplexing a signal of a first frequency and the information signal is inputted into the first phase modulator,
wherein a drive signal generated by multiplexing a signal of a second frequency and the information signal is inputted into the second phase modulator; and
wherein the QPSK modulator controls the bias voltages which is applied to the phase modulators so that the detected amounts of the signals of the first frequency and the second frequency which are extracted from the modulated light may be the minimum respectively.

8. The QPSK modulator according to claim 7,
wherein the QPSK modulator further comprises:
at least one oscillator for outputting a signal having the first frequency and a signal having the second frequency which is different from the first frequency;
a divider for extracting a part of the light outputted from the combiner;
a photoelectric converter for photo-electrical converting the light extracted by the divider to an electric signal; and
filters for extracting the components of the first frequency and the second frequency from the electric signal converted with the photoelectric converter,
wherein a first drive signal of the drive signals generated by applying amplitude modulation with the information signal to the signals of the first frequency is inputted into the first phase modulator;
wherein a second drive signal of the drive signals generated by applying amplitude modulation with the information signal to the signals of the second frequency is inputted into the second phase modulator; and
wherein the QPSK modulator control the bias voltages which is applied to the phase modulators so that the detected amounts of the signals of the first frequency and the second frequency which are extracted by the filters may be the minimum respectively.

9. The QPSK modulator according to claim 8, wherein the phase modulators are MZ modulators which are driven so that the amplitude modulation at a drive signal level corresponding to the case where the phase of the optical output of the MZ modulators is “0” and the amplitude modulation at a drive signal level corresponding to the case where the phase of the optical output thereof is “π” may take an in-phase.

10. The QPSK modulator according to claim 9, further comprising
drivers to add drive signals to each of the phase modulators and wherein
each of the drivers comprises:
a first adder for adding the first or second frequency signal and a predetermined DC bias;
an amplifier for amplifying the information signal to a level where the phase of the optical output signal is modulated between “0” and “π”; and
a second adder for generating signal to be inputted to each of the MZ modifiers by adding the output signal from the first adder and the output signal from the amplifier.

11. The QPSK modulator according to claim 8, wherein the QPSK modulator feeds back a detected amount to a voltage applied to the phase shifter so that the phase shift amount may be π/2, the detected amount of signals having the frequency of the difference between or the sum of the first frequency and the second frequency which are extracted by the filters.

12. The QPSK modulator according to claim 7, wherein the first frequency is equal to the second frequency.

13. A QPSK modulator which outputs modulated light, comprising:
two phase modulators implemented in parallel for outputting the light phase-modulated with input an information signal;
a phase shifter for shifting the phase of the light phase-modulated with the first phase modulator of the two phase modulators and for outputting the phase-shifted light; and
a combiner for combining output light from the phase shifter and output light from the second phase modulator,
wherein the QPSK modulator feeds back a detected amount to a voltage which is applied to the phase shifter so that the phase shift amount may be π/2, the detected amount of signals having frequencies lower than the bit rates of the information signal extracted from the modulated light.

14. The QPSK modulator according to claim 13, wherein
the QPSK modulator further comprises:
a divider for extracting a part of the light outputted from the combiner;
a photoelectric converter for photo-electrical converting the light extracted by the divider unit to an electric signal; and
a filter for extracting the signals having frequencies lower than the bit rates of the information signal from the electric signal converted by the photoelectric converter,
wherein the QPSK modulator feeds back a detected amount to a voltage which is applied to the phase shifter so that the phase shift amount may be π/2, the detected amount of the signals having frequencies lower than the bit rates of the information signal extracted by the filter.
